(19) United States
(12) Patent Application Publication
(10) Pub. No.: US 2023/0093331 A1
(43) Pub. Date: Mar. 23, 2023

(54) SHOPPER-BASED COMMERCE DRIVEN PRESENTATION OF REQUIRED-BUT-MISSING PRODUCT RELATED INFORMATION

(71) Applicant: International Business Machines Corporation, Armonk, NY (US)

(72) Inventors: Jacob Ryan Jepperson, St. Paul, MN (US); Thomas Jefferson Sandridge, Tampa, FL (US); Jeremy R. Fox, Georgetown, TX (US); Raghuveer Prasad Nagar, Kota (IN); Reji Jose, Bangalore (IN); Jagadesh Ramaswamy Hulugundi, Bangalore (IN)

(21) Appl. No.: 17/448,538

(22) Filed: Sep. 23, 2021

(51) Int. Cl. G06Q 30/06; G06N 20/00; G06K 9/00; G06T 11/00

(52) U.S. Cl. CPC G06Q 30/0643; G06Q 30/0633; G06Q 30/0631; G06N 20/00; G06K 9/00671; G06T 11/00; G06Q 20/321

(57) ABSTRACT

In an approach for a shopper-based commerce driven presentation of required-but-missing product related information, a processor detects a user viewing a physical product via a mixed reality device. A processor identifies a preferred environment for the physical product from a personal shopper profile of the user. A processor generates via the mixed reality device a depiction of the preferred environment. A processor determines whether the physical product can be overlaid in the preferred environment. A processor enables the user to purchase a product based on the determination.

### BACKGROUND OF THE INVENTION

The present invention relates generally to the field of data processing, and more particularly to a shopper-based commerce driven presentation of required-but-missing product related information.

Mixed reality (MR), sometimes referred to as hybrid reality, is the merging of the real-world with the digital world to produce an environment where physical and digital objects can co-exist and interact in real time. MR does not take place in only the physical world or the virtual world, but rather takes place in a mix of reality and virtual reality, encompassing both augmented reality and augmented reality via immersive technology.

Augmented reality (AR) is a live direct or indirect view of a physical, real-world environment the elements of which are augmented by computer-generated sensory input such as sound, video, graphics, or global positioning system (GPS) data. AR is related to a more general concept called computer-mediated reality, in which a view of reality is modified (possibly even diminished rather than augmented) by a computer. AR enhances one's current perception of reality, whereas in contrast, virtual reality replaces the real world with a simulated one. AR techniques are typically performed in real time and in semantic context with environmental elements, such as overlaying supplemental information like scores over a live video feed of a sporting event.

With the help of advanced AR technology (e.g., adding computer vision and object recognition), the information about the surrounding real world of the user becomes interactive and digitally manipulable. Information about the environment and its objects is overlaid on the real world. This information can be virtual or real, e.g., seeing other real sensed or measured information such as electromagnetic radio waves overlaid in exact alignment with where they are in space. AR brings the components of the digital world into a person's perceived real world.

Hardware components for AR include a processor, a display, sensors, and input devices. Modern mobile computing devices like smartphones and tablet computers contain these elements which often include a camera and microelectromechanical system (MEMS) sensors, such as an accelerometer, a GPS, and a solid-state compass, making them suitable AR platforms.

Various technologies are used in AR rendering including optical projection systems, monitors, hand-held devices, and display systems worn on the human body. A head-mounted display (HMD) is a display device paired to a harness or helmet. HMDs place images of both the physical world and virtual objects over the user's field of view. Modern HMDs often employ sensors for six degrees of freedom monitoring that allow the system to align virtual information to the physical world and adjust accordingly with the user's head movements. HMDs can provide virtual reality users mobile and collaborative experiences.

AR displays can be rendered on devices resembling eyeglasses. Versions include eyewear that employ cameras to intercept the real-world view and re-display its augmented view through the eye pieces and devices in which the AR imagery is projected through or reflected off the surfaces of the eyewear lens pieces. A heads-up display, also known as a HUD, is a transparent display that presents data without requiring users to look away from their usual viewpoints. A precursor technology to AR heads-up display was first developed for pilots in the 1950s. The precursor technology projected simple flight data into their line of sight thereby enabling them to keep their “heads up” and not look down at the instruments. Near eye AR devices can be used as portable head-up displays as they can show data, information, and images while the user views the real world. Many definitions of AR only define it as overlaying the information. This is basically what a heads-up display does; however, practically speaking, AR is expected to include registration and tracking between the superimposed perceptions, sensations, information, data, and images and some portion of the real world.

### SUMMARY

Aspects of an embodiment of the present invention disclose a method, computer program product, and computer system for a shopper-based commerce driven presentation of required-but-missing product related information. A processor detects a user viewing a physical product via a mixed reality device. A processor identifies a preferred environment for the physical product from a personal shopper profile of the user. A processor generates via the mixed reality device a depiction of the preferred environment. A processor determines whether the physical product can be overlaid in the preferred environment. A processor enables the user to purchase a product based on the determination.

In some aspects of an embodiment of the present invention, subsequent to enabling the user to purchase the product based on the determination, a processor requests feedback from the user regarding the determination. A processor receives the feedback from the user. A processor improves the accuracy of the determination using reinforcement learning. A processor stores the feedback from the user in a database.

In some aspects of an embodiment of the present invention, a processor identifies the physical product viewed by the user via the mixed reality device. A processor downloads a set of information about the physical product viewed from the personal shopper profile of the user onto the mixed reality device.

In some aspects of an embodiment of the present invention, the personal shopper profile of the user includes information about one or more shopping needs of the user, information about the physical product, information about the preferred environment, information about one or more shopping preferences of the user, and information about a budget of the user.

In some aspects of an embodiment of the present invention, responsive to determining the physical product cannot be overlaid in the preferred environment, a processor generates one or more alternative micro locations within the preferred environment in which the physical product can be placed. A processor enables the user to select a first alternative micro location from the one or more alternative micro locations. A processor enables the user to orient the physical product in the first alternative micro location.

In some aspects of an embodiment of the present invention, subsequent to enabling the user to orient the physical product in the first alternative micro location, a processor determines whether the physical product can be overlaid in the first alternative micro location. Responsive to determining the physical product cannot be overlaid in the first alternative micro location, a processor automatically rearranges the one or more moveable items located within the first alternative micro location in order for the physical product to be overlaid at the first alternative micro location.

In some aspects of an embodiment of the present invention, subsequent to automatically rearranging the one or more moveable items located within the first alternative micro location in order for the physical product to be overlaid at the first alternative micro location, a processor determines whether the physical product can be overlaid at the first alternative micro location. Responsive to determining the physical product cannot be overlaid at the first alternative micro location, a processor generates one or more alternative options to the physical product. A processor overlays an alternative option from the one or more alternative options to the physical product at the first alternative micro location.

In some aspects of an embodiment of the present invention, the one or more alternative options to the physical product includes a cross-sell product and an up-sell product.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps for a setup component of a shopping support program, on a server within the distributed data processing environment of FIG. 1, in accordance with an embodiment of the present invention;

FIG. 3 is a flowchart illustrating the operational steps of the shopping support program, on the server within the distributed data processing environment of FIG. 1, in accordance with an embodiment of the present invention;

FIG. 4 is a flowchart illustrating, in greater detail, the operational steps of a determination step of the shopping support program, on the server within the distributed data processing environment of FIG. 1, in accordance with an embodiment of the present invention; and

FIG. 5 is a block diagram illustrating the components of a computing device within the distributed data processing environment of FIG. 1, in accordance with an embodiment of the present invention.

### DETAILED DESCRIPTION

Embodiments of the present invention recognize that, when shopping in a physical store, shoppers are dependent on the information printed on the label of a product and on the information displayed on associated signage. Embodiments of the present invention recognize that, if a shopper needs additional information about a product before buying, the shopper must either talk to a sales associate or use the shopper's personal mobile device to research the product on the Internet. Additionally, embodiments of the present invention recognize that, when shopping in a physical store for certain products such as furniture, wall décor, decorative accessories, and antiques, a shopper's ability to visualize the product in a location of preference would be a valuable resource to assess whether the product fits, physically and aesthetically, in the location of preference. Embodiments of the present invention recognize that this type of resource is typically provided to online shoppers, but not to in-store shoppers. Therefore, embodiments of the present invention recognize the need to provide the product related information and the means of visualizing the product in a location of preference to the in-store shopper.

Embodiments of the present invention provide a mixed reality-based system and method to dynamically determine the product related information (also referred to as the “required-by-shopper-but-missing-on-the-product-being-viewed” information) which the shopper needs to make a buying decision based on the shopper's predicted product preference and usage, and then to present the product related information on the product the shopper views or on either a cross-sell or an up-sell product (also referred to as the “derived-and-presented” information) to the shopper using dynamically generated text and media content including audio, video, and images via a mixed reality device.

Implementation of embodiments of the present invention may take a variety of forms, and exemplary implementation details are discussed subsequently with reference to the Figures.

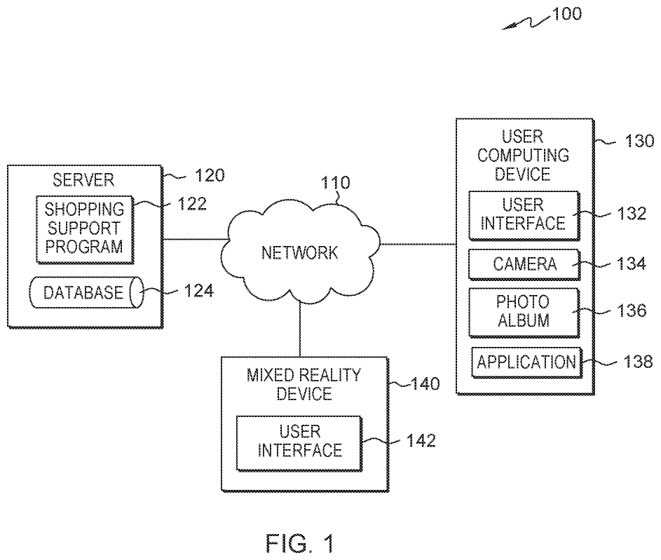

FIG. 1 is a block diagram illustrating a distributed data processing environment, generally designated 100, in accordance with an embodiment of the present invention. In the depicted embodiment, distributed data processing environment 100 includes server 120, user computing device 130, and mixed reality device 140, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, mixed reality device 140, and other computing devices (not shown) within distributed data processing environment 100.

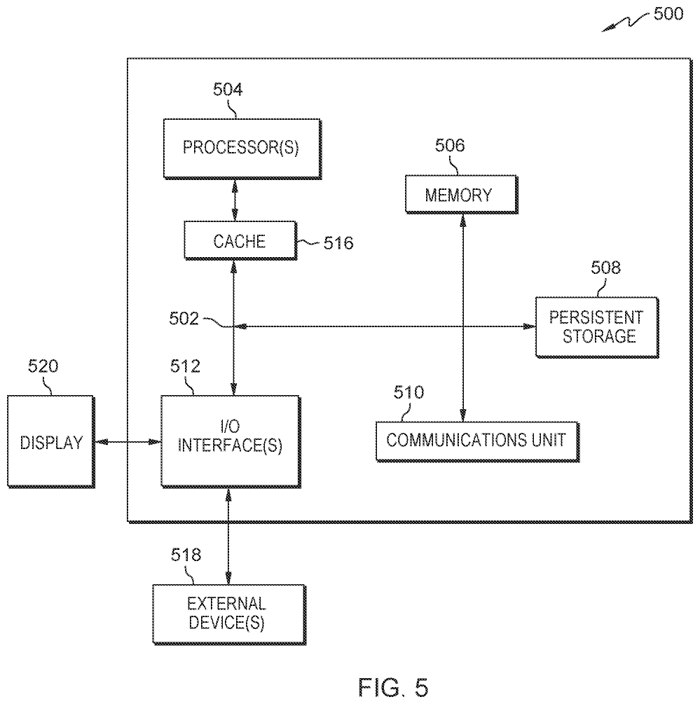

Server 120 operates to run shopping support program 122 and to send and/or store data in database 124. In an embodiment, server 120 can send data from database 124 to user computing device 130 and/or mixed reality device 140. In an embodiment, server 120 can receive data in database 124 from user computing device 130 and/or mixed reality device 140. In one or more embodiments, server 120 can be a standalone computing device, a management server, a web server, a mobile computing device, or any other electronic device or computing system capable of receiving, sending, and processing data and capable of communicating with user computing device 130 and mixed reality device 140 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, mixed reality device 140, and other computing devices (not shown) within distributed data processing environment 100 via network 110. Server 120 may include internal and external hardware components, as depicted and described in further detail in FIG. 5.

Shopping support program 122 operates to determine the product related information the shopper needs to make a buying decision based on the shopper's predicted product preference and usage, and then to present the product related information on the shopper's selected product or on either a cross-sell product or an up-sell product to the shopper using dynamically generated text and media content including audio, video, and images via a mixed reality device. In the depicted embodiment, shopping support program 122 is a standalone program. In another embodiment, shopping support program 122 may be integrated into another software product, such as a shopping cart software (i.e., software designed to help brick and mortar businesses sell goods and service at the brick and mortar businesses' physical premises and software designed to help online merchants sell goods and services from the online merchants' eCommerce sites). In the depicted embodiment, shopping support program 122 resides on server 120. In another embodiment, shopping support program 122 may reside on user computing device 130 or on another computing device (not shown), provided that shopping support program 122 has access to network 110.

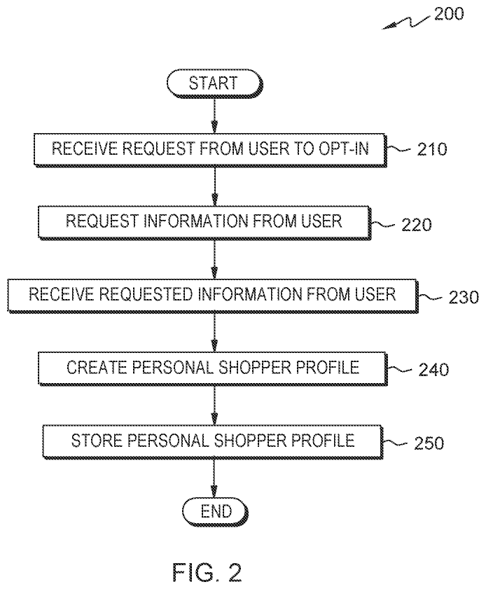

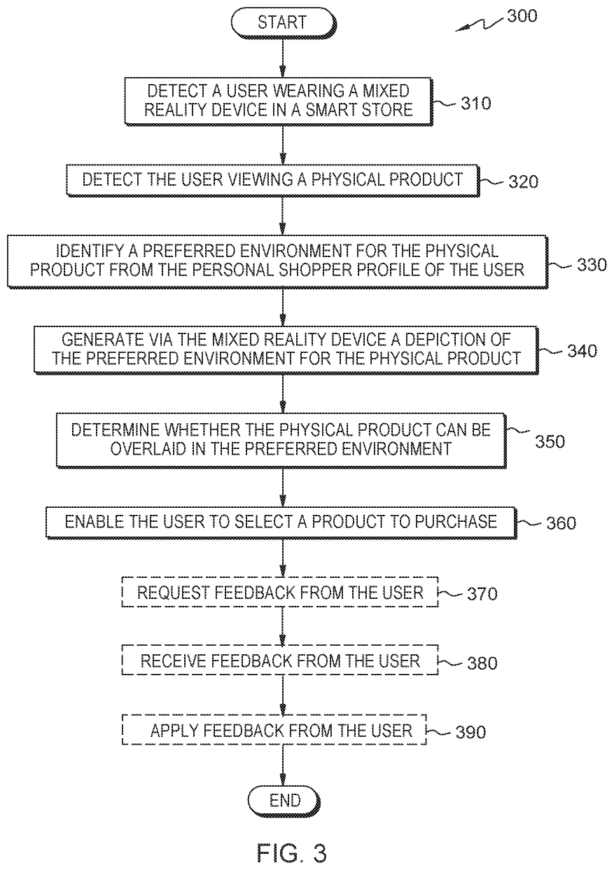

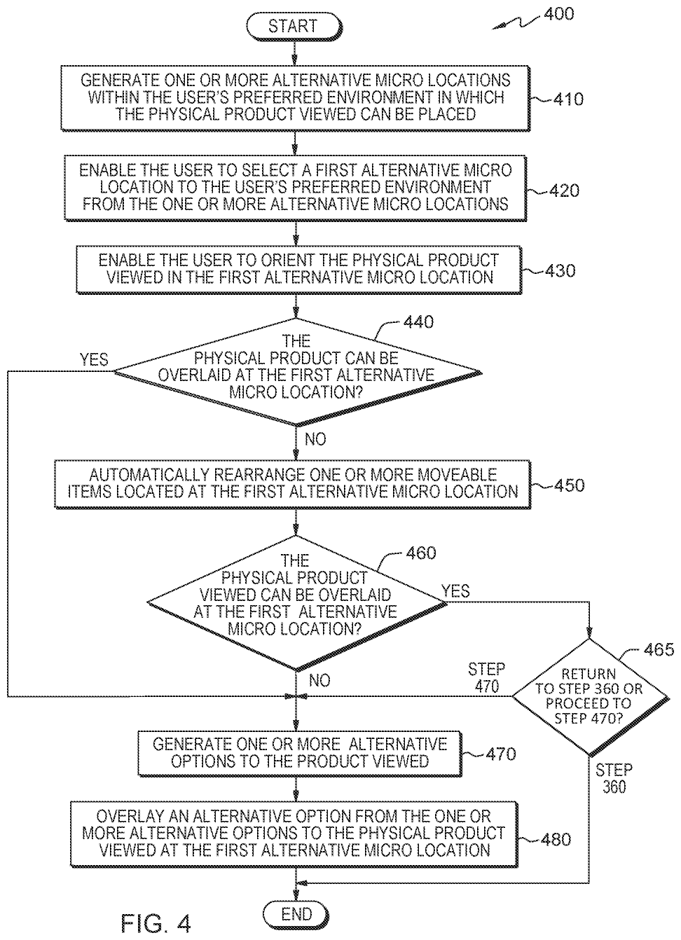

In an embodiment, the user of user computing device 130 registers with server 120 (e.g., via a corresponding application, e.g., application 138). For example, the user completes a registration process (e.g., user validation), provides information to create a personal shopper profile, and authorizes the collection, analysis, and distribution (i.e., opts-in) of relevant data on identified computing devices (e.g., on user computing device 130) by server 120 (e.g., via shopping support program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points for the smart store (i.e., an augmented environment of a retail store), the user, and/or the data collected); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. For example, the user can opt-in to provide data to all smart stores, to a subset of smart stores, or to no smart stores. Such preferences can be stored in a database, e.g., database 124. The setup component of shopping support program 122 is depicted and described in further detail with respect to FIG. 2. The overall operational steps of shopping support program 122 are depicted and described in further detail with respect to FIG. 3. The operational steps of a determination step of the shopping support program are depicted and described in further detail with respect to FIG. 4.

Database 124 operates as a repository for data received, used, and/or generated by shopping support program 122. A database is an organized collection of data. Data includes, but is not limited to, information about user preferences (e.g., general user system settings such as alert notifications for user computing device 130); information about alert notification preferences; the personal shopper profile of the user including the information about the user's shopping needs; information about the physical product viewed; information about the user's location of preference; information about the user's shopping preferences; information about the user's budget; the plurality of images and/videos of the user's home and the various rooms in the user's home to be used as information about the user's location of preference; the feedback received from the user; and any other data received, used, and/or generated by shopping support program 122.

Database 124 can be implemented with any type of device capable of storing data and configuration files that can be accessed and utilized by server 120, such as a hard disk drive, a database server, or a flash memory. In an embodiment, database 124 is accessed by shopping support program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that shopping support program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Shopping support program 122 enables the authorized and secure processing of personal data.

Shopping support program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Shopping support program 122 provides information regarding personal and/or confidential company data and the nature (e.g., type, scope, purpose, duration, etc.) of the processing. Shopping support program 122 provides the user with copies of stored personal and/or confidential company data. Shopping support program 122 allows the correction or completion of incorrect or incomplete personal and/or confidential company data. Shopping support program 122 allows for the immediate deletion of personal and/or confidential company data.

User computing device 130 operates to run user interface 132 through which a user can interact with shopping support program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with shopping support program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132, camera 134, photo album 136, and application 138. User computing device 130 may include components as described in further detail in FIG. 5.

User interface 132 operates as a local user interface between shopping support program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from shopping support program 122 to a user via network 110. User interface 132 can also display or present alerts including information (such as graphics, text, and/or sound) sent from shopping support program 122 to a user via network 110. In an embodiment, user interface 132 is capable of sending and receiving data (i.e., to and from shopping support program 122 via network 110, respectively). Through user interface 132, a user can opt-in to shopping support program 122; create a personal shopper profile; input information; set user preferences and alert notification preferences; receive a result of the determination; review the result of the determination; accept or reject the result of the determination; purchase a product based on the result of the determination; receive a request for feedback regarding the result of the determination; and input feedback regarding the result of the determination.

A user preference is a setting that can be customized for a particular user. A set of default user preferences are assigned to each user of shopping support program 122. A user preference editor can be used to update values to change the default user preferences. User preferences that can be customized include, but are not limited to, general user system settings, specific personal shopper profile settings, alert notification settings, and machine-learned data collection/storage settings.

Specific personal shopper profile settings provide a tailored delivery of contextual content. Shopping support program 122 delivers the amount of contextual content required by the user, based on the personal preferences set by the user. The amount of contextual content required by the user varies, but may be an unabridged content comparison (i.e., the complete text that has not been cut down or shortened in any form or manner), an abridged content comparison (i.e., a shortened piece of content that does not lose sense of the overall, complete content), a summary content comparison (i.e., a paragraph style summary that conveys all of the points in summary format), or an executive summary of content comparison (i.e., a shortened summary that is about three to five sentences in length).

Machine-learned data is a user's personalized corpus of data. Machine-learned data includes, but is not limited to, data regarding information and/or products that the user has seen or experienced, past results of iterations of shopping support program 122 and a user's previous response to an alert notification sent by shopping support program 122. Shopping support program 122 self-learns by tracking user activity and improves with each iteration of shopping support program 122. By retaining such data, shopping support program 122 ensures that repetitive information is not generated and sent to the user. Instead, shopping support program 122 bypasses the repetitive information and locates new information for the user.

Mixed reality device 140 is a wearable device, such as Google Glass™, that provides a user who is wearing mixed reality device 140 with an AR view of a physical product. It should be appreciated, however, that any other suitable means of mixed reality device 140 may be used. Generally, AR is a live direct or indirect view of a physical, real-world environment whose elements are augmented (or supplemented) by computer-generated sensory input such as sound, video, or graphics. In the depicted embodiment, mixed reality device 140 includes an instance of user interface 142. In an embodiment, mixed reality device 140 performs a secure handshake with user computing device 130 using user interface 142.

As used herein, the term “augmented reality” (“AR”) refers to any technique for augmenting a real-world environment, such as a live video captured through a camera or recorded video, using computer-generated sensory input such as sound, video, graphics, or GPS data.

User interface 142 represents the interface between the user and mixed reality device 140. In some embodiments, user interface 142 is a graphical user interface (GUI), a web user interface (WUI), and/or a voice user interface (VUI) that can display (i.e., visually) or present (i.e., audibly) text, user options, application interfaces, and instructions for operations sent from shopping support program 122 to a user via network 110. User interface 142 can also display or present alerts including information (such as graphics, text, and/or sound) sent from shopping support program 122 to a user via network 110. In an embodiment, user interface 142 is capable of sending and receiving data (i.e., to and from shopping support program 122 via network 110, respectively). Through user interface 142, a user can view a physical product and/or an alternative option to the physical product; view a location of preference and/or an alternative option to the location of preference; orient a physical product in a particular position; and select a product to purchase.

FIG. 2 is a flowchart, generally designated 200, illustrating the operational steps for a setup component of shopping support program 122 on server 120 within distributed data processing environment 100 of FIG. 1, in accordance with an embodiment of the present invention. In an embodiment, shopping support program 122 completes a one-time setup with a user. The one-time setup allows for shopping support program 122 to capture relevant information about the user to create a personal shopper profile. In an embodiment, shopping support program 122 receives a request from the user to opt-in. In an embodiment, shopping support program 122 requests information from the user. In an embodiment, shopping support program 122 receives the requested information from the user. In an embodiment, shopping support program 122 creates a personal shopper profile. In an embodiment, shopping support program 122 stores the personal shopper profile. It should be appreciated that the process depicted in FIG. 2 illustrates one possible iteration of shopping support program 122, which may be repeated for each opt-in request received by shopping support program 122.

In step 210, shopping support program 122 receives a request from a user to opt-in. A user may include, but is not limited to, a person who shops for a good, product, or service through any sales channel including, but not limited to, a smart store (i.e., an augmented environment of a retail store) or an e-store (i.e., a virtual store of a retailer who sells goods, products, or services over the Internet). In an embodiment, shopping support program 122 receives a request from a user to opt-in to shopping support program 122. In an embodiment, shopping support program 122 receives a request from a user to opt-in to shopping support program 122 through user interface 132 of user computing device 130. By opting-in, the user agrees to share at least some data with database 124.

In step 220, shopping support program 122 requests information from the user. In an embodiment, responsive to receiving a request from a user to opt-in, shopping support program 122 requests information from the user. In an embodiment, shopping support program 122 requests information from the user to create a personal shopper profile. In an embodiment, shopping support program 122 requests information from the user through user interface 132 of user computing device 130. Information requested from the user includes, but is not limited to, information about user preferences (e.g., general user system settings such as alert notifications for user computing device 130); information about alert notification preferences (e.g., alert notification preview, alert notification style (e.g., alert notification appearing on lock screen, notification center, and/or banner; alert notification appearing temporary or persistently; alert notification sound on or off; alert notification grouping automatically, by application, or off), and alert notification frequency); information about the user's shopping needs; information about the physical product viewed; information about the user's location of preference; information about the user's shopping preferences; and information about the user's budget.

Information about the user's shopping needs includes, but is not limited to, the physical product for which the user is shopping and the quantity of the physical product needed. Information about the user's shopping needs is derived from data sources including, but not limited to, the user (i.e., the user inputting personal information into the user's personal shopper profile), the user's social media accounts (e.g., the user liking or commenting on a company's post advertising a product), the user's personal calendar, the user's IoT based devices, and the user's browsing history (i.e., a record of past visited sites).

For example, a user is looking to purchase a new mobile phone. Shopping support program 122 gathers information about the user's shopping needs from the information the user inputted into the user's personal shopper profile. In particular, the user inputted the user's occupation, a photographer, into the user's personal shopper profile. Shopping support program 122 derives from this information that the user will want to know more about the camera lens manufacturer when purchasing the new mobile phone.

In another example, a user is looking to purchase a CD. Shopping support program 122 gathers information about the user's shopping needs from the user's IoT based devices. Shopping support program 122 learns that the user listens to a particular composer frequently. Shopping support program 122 recognizes that the CD the user is viewing has a track written by the particular composer.

In yet another example, a user is looking to purchase A2 cow milk. Shopping support program 122 gathers information about the user's shopping needs from the user's browsing history. Shopping support program 122 learns that the user recently searched for stores that sell A2 cow milk within a five-mile radius of the user's current location.

Information about the physical product includes, but is not limited to, 3D images of the physical product; physical characteristics of the physical product; and other technical specifications of the physical product. Information about the physical product is derived from a catalog management system.

Information about the user's location of preference (hereinafter referred to as the “preferred environment”) is the location where the user would prefer to place the physical product (e.g., furniture, wall décor, decorative accessories, and antiques) in the user's home. Information about the user's preferred environment is gathered using one or more IoT devices (e.g., cameras, sensors, virtual assistants) of the user. The one or more IoT devices of the user reconstruct the user's home and the various rooms in the user's home as images and/or videos. If necessary, the user manually captures pictures and/or videos of the user's home and the various rooms in the user's home using camera 134 on user computing device 130. In the alternative, the user provides pictures and/or videos of the user's home and the various rooms previously captured by camera 134 and stored in photo album 136 on user computing device 130. Information about the user's preferred environment includes, but is not limited to, IoT data regarding the real estate specifications of the user's home (i.e., the overall dimensions of the user's home and the dimensions of various rooms in the user's home), the technical services provided in the user's home, the interior and exterior design of the user's home, a description of the floors and walls in the user's home, the usage of the various rooms in the user's home, the identification of items in the various rooms in the user's home, whether the items in the various rooms in the user's home are movable or fixed, the available space in the various rooms in the user's home for a new product, the location of the user's home, and the current and predicted weather conditions at the user's home.

Information about the user's shopping preferences includes, but is not limited to, the smart store or e-store where the user prefers to shop, the quality of the product the user likes or dislikes, the availability of the product, the delivery method, the payment method, the security of the user's data when placing an order or when purchasing the product, other services provided when purchasing the product. Information about the user's shopping preferences is derived from data sources including, but not limited to, the user, the user's social media accounts, the user's personal calendar, the user's IoT based devices, and the user's browsing history.

In an embodiment, shopping support program 122 requests access to camera 134 on user computing device 130. In an embodiment, shopping support program 122 requests access to camera 134 on user computing device 130 to capture a plurality of images and/videos of the user's home and the various rooms in the user's home. In an embodiment, shopping support program 122 requests access to camera 134 on user computing device 130 to capture a plurality of images and/videos of the user's home and the various rooms in the user's home to be used as information about the user's preferred environment. In another embodiment, shopping support program 122 requests access to camera 134 on user computing device 130 to search a scene for the physical product. In an embodiment, shopping support program 122 stores the plurality of images and/or videos as part of the user's personal shopper profile in a database, e.g., database 124.

In an embodiment, shopping support program 122 requests access to photo album 136 on user computing device 130. In an embodiment, shopping support program 122 requests access to photo album 136 to gather a plurality of images and/videos of the user's home and the various rooms in the user's home. In an embodiment, shopping support program 122 enables the user to permit shopping support program 122 access to all photos, to select photos, or to no photos. In an embodiment, shopping support program 122 requests access to photo album 136 through user interface 132 of user computing device 130.

In step 230, shopping support program 122 receives the requested information from the user. In an embodiment, responsive to requesting information from the user, shopping support program 122 receives the requested information from the user. In an embodiment, shopping support program 122 receives the requested information from the user through user interface 132 of user computing device 130. In another embodiment, shopping support program 122 receives the requested information from the user's social media accounts, the user's personal calendar, the user's IoT based devices, and/or the user's browsing history through user computing device 130.

In step 240, shopping support program 122 creates a personal shopper profile. In an embodiment, responsive to receiving the requested information from the user, shopping support program 122 creates a personal shopper profile. In an embodiment, shopping support program 122 creates a personal shopper profile for the user. In an embodiment, shopping support program 122 creates a personal shopper profile with information input by the user during setup regarding the user (i.e., information necessary to create a personal shopper profile, information about the user's shopping needs; information about the physical product; information about the user's preferred environment; information about the user's shopping preferences; and information about the user's budget) as well as user preferences and alert notification preferences.

In step 250, shopping support program 122 stores the personal shopper profile. In an embodiment, responsive to creating a personal shopper profile, shopping support program 122 stores the personal shopper profile. In an embodiment, shopping support program 122 stores the personal shopper profile in a database, e.g., database 124.

FIG. 3 is a flowchart, generally designated 300, illustrating the operational steps of shopping support program 122 on server 120 within distributed data processing environment 100 of FIG. 1, in accordance with an embodiment of the present invention. In an embodiment, shopping support program 122 operates to determine the product related information the shopper needs to make a buying decision based on the shopper's predicted product preference and usage, and then to present the product related information on the shopper's selected physical product or on either a cross-sell product or an up-sell product to the shopper using dynamically generated text and media content including audio, video, and images via a mixed reality device. It should be appreciated that the process depicted in FIG. 3 illustrates one possible iteration of the process flow, which may be repeated for each physical product viewed by the user.

In step 310, shopping support program 122 detects a user wearing mixed reality device 140 in a smart store. In an embodiment, shopping support program 122 enables a user to login to application 138. In an embodiment, shopping support program 122 enables a user to login to application 138 through user interface 132 of user computing device 130. In an embodiment, shopping support program 122 downloads the personal shopper profile of the user from database 124. In an embodiment, shopping support program 122 loads the associated shopper data from the user's personal shopper profile onto mixed reality device 140. The associated shopper data from the user's personal shopper profile includes, but is not limited to, information about the user's shopping needs, information about the user's preferred environment, information about the user's shopping preferences, and information about the user's budget. Mixed reality device 140 is worn by the user while shopping in a smart store. Mixed reality device 140 is either personally owned by the user or provided by the smart store in which the user is shopping.

In step 320, shopping support program 122 detects the user viewing a physical product. In an embodiment, responsive to enabling the user to login to application 133, shopping support program 122 detects the user viewing a physical product (hereinafter referred to as “the physical product viewed”). In an embodiment, shopping support program 122 identifies the physical product viewed. In an embodiment, shopping support program 122 downloads information about the physical product viewed from the user's personal shopper profile stored in database 124. In another embodiment, shopping support program 122 downloads information about the physical product viewed from a database of a smart store. In an embodiment, shopping support program 122 loads information about the physical product viewed from the personal shopper profile of the user onto mixed reality device 140. In an embodiment, shopping support program 122 loads information about the physical product viewed from the database of the smart store onto mixed reality device 140.

In step 330, shopping support program 122 matches the information about the user's preferred environment to the information about the physical product viewed. In an embodiment, responsive to detecting the user viewing the physical product, shopping support program 122 matches the information about the user's preferred environment to the information about the physical product viewed. In an embodiment, shopping support program 122 identifies the preferred environment for the physical product viewed from information stored in the personal shopper profile of the user. In an embodiment, shopping support program 122 determines how the physical product viewed will fit in the user's home using the information about the physical product viewed (e.g., fit in the user's home in terms of size, color, and design).

In step 340, shopping support program 122 generates via mixed reality device 140 a depiction of the preferred environment with the physical product viewed. In an embodiment, responsive to matching the information about the user's preferred environment to the information about the physical product viewed, shopping support program 122 generates via mixed reality device 140 a depiction of the preferred environment with the physical product viewed. In an embodiment, shopping support program 122 overlays the user's preferred environment on the physical product viewed. For example, the user wishes to visualize a flower vase, the physical product viewed, on the user's coffee table in the user's living room, the user's preferred environment. Shopping support program 122 overlays an image of the user's coffee table in the user's living room on the flower vase to provide the user with a visualization of how the physical product viewed will look in the user's preferred environment.

In step 350, shopping support program 122 determines whether the physical product viewed can be overlaid in the preferred environment. In an embodiment, responsive to generating via mixed reality device 140 a depiction of the preferred environment with the physical product viewed, shopping support program 122 determines whether the physical product viewed can be overlaid in the preferred environment. Step 350 (hereinafter referred to as the “determination”) is described in further detail with respect to flowchart 400 in FIG. 4.

In step 360, shopping support program 122 displays the physical product viewed and one or more alternative options to the physical product viewed on mixed reality device 140. In an embodiment, responsive to determining whether the physical product viewed can be overlaid in the preferred environment, shopping support program 122 displays the physical product viewed and one or more alternative options to the physical product viewed on mixed reality device 140. In another embodiment, shopping support program 122 displays the physical product viewed and the one or more alternative options to the physical product viewed on user interface 132 of user computing device 130.

In an embodiment, shopping support program 122 enables the user to select a product to purchase. In an embodiment, shopping support program 122 enables the user to select a product to purchase on user interface 142 of mixed reality device 140. In another embodiment, shopping support program 122 enables the user to select a product to purchase on user interface 132 on user computing device 130.

In an embodiment, shopping support program 122 enables the user to select the physical product viewed or an alternative option from the set of alternative options to the physical product viewed. For example, the user selects a sofa, the physical product viewed, and wishes to visualize the sofa in the user's living room, the user's preferred environment. Shopping support program 122 determines that the sofa will not fit in the user's living room. Shopping support program 122 provides suggestions of similar products to the physical product viewed, such as a sleeker sofa and a loveseat, that will fit in the user's living room.

In step 370, shopping support program 122 requests feedback from the user. In an embodiment, responsive to displaying the physical product viewed and a set of alternative options to the physical product viewed on mixed reality device 140, shopping support program 122 requests feedback from the user. In an embodiment, shopping support program 122 requests feedback from the user regarding the determination. In an embodiment, shopping support program 122 requests feedback from the user through user interface 132 of user computing device 130.

In step 380, shopping support program 122 receives feedback from the user. In an embodiment, responsive to requesting feedback from the user, shopping support program 122 receives feedback from the user. In an embodiment, shopping support program 122 receives feedback from the user regarding the determination. In an embodiment, shopping support program 122 receives feedback from the user as a satisfaction rating. In an embodiment, shopping support program 122 receives feedback from the user through user interface 132 of user computing device 130.

In step 390, shopping support program 122 applies the feedback received from the user. In an embodiment, responsive to receiving feedback from the user, shopping support program 122 applies the feedback received from the user. In an embodiment, shopping support program 122 applies the feedback received from the user in order to improve the accuracy of the determination. In an embodiment, shopping support program 122 applies the feedback received from the user using reinforcement learning. In an embodiment, shopping support program 122 stores the feedback from the user in a database, e.g., database 124.

In some embodiments, shopping support program 122 may perform steps 370, 380, and 390 as optional steps.

FIG. 4 is a flowchart, generally designated 400, illustrating, in greater detail, the operational steps of determination step 350 of shopping support program 122 on server 122 within distributed data processing environment 100 of FIG. 1, in accordance with an embodiment of the present invention. In an embodiment, shopping support program 122 determines whether the physical product can be overlaid in the preferred environment. It should be appreciated that the process depicted in FIG. 4 illustrates one possible iteration of determination step 350 of shopping support program 122, which may be repeated for each physical product viewed by the user.

In step 410, shopping support program 122 generates one or more alternative micro locations within the user's preferred environment in which the physical product viewed can be placed. In an embodiment, shopping support program 122 generates one or more alternative micro locations within the user's preferred environment that better suit the physical product viewed. In an embodiment, shopping support program 122 considers the usage of a room when making these suggestions. For example, shopping support program 122 will not show the user an option to place a sofa in a bathroom. In an embodiment, shopping support program 122 considers the dimensions of the physical product viewed when making these suggestions. For example, shopping support program 122 will not show the user an option to place a sofa in a living room if the sofa is too large to fit in the living room. In an embodiment, shopping support program 122 displays the user's preferred environment and the one or more alternative micro locations within the user's preferred environment on mixed reality device 140. In another embodiment, shopping support program 122 displays the user's preferred environment and the one or more alternative micro locations within the user's preferred environment on user interface 132 of user computing device 130.

In step 420, shopping support program 122 enables the user to select a first alternative micro location to the user's preferred environment from the one or more alternative micro locations. In an embodiment, responsive to generating the one or more alternative micro locations within the user's preferred environment in which the physical product viewed can be placed, shopping support program 122 enables the user to select a first alternative micro location to the user's preferred environment from the one or more alternative micro locations. In an embodiment, shopping support program 122 enables the user to select a first alternative micro location to the user's preferred environment where the physical product viewed can be placed in the user's home. Continuing the example from step 340, the user wishes to visualize the flower vase on the user's coffee table in the user's living room. Shopping support program 122 overlays images of the user's coffee table in the user's living room on the flower vase to provide the user with a visualization of how the physical product viewed will look in the user's preferred environment. Shopping support program 122 also overlays images of the user's side table and dining table in the user's living room on the flower vase to provide the user with a visualization of how the physical product viewed will look in one or more alternative micro locations within the user's preferred environment.

In step 430, shopping support program 122 enables the user to orient the physical product viewed in the first alternative micro location. In an embodiment, responsive to enabling the user to select a first alternative micro location to the user's preferred environment from the one or more alternative micro locations, shopping support program 122 enables the user to orient the physical product viewed in the first alternative micro location. In an embodiment, shopping support program 122 enables the user to orient the physical product viewed in a particular position using user interface 142 on mixed reality device 140. In another embodiment, shopping support program 122 enables the user to orient the physical product viewed in a particular position using user interface 132 on user computing device 130.

In another embodiment, shopping support program 122 enables the user to rearrange moveable items in a room to fit the physical product viewed. In an embodiment, shopping support program 122 enables the user to rearrange moveable items in a room to fit the physical product viewed using user interface 142 on mixed reality device 140. In another embodiment, shopping support program 122 enables the user to rearrange moveable items in a room to fit the physical product viewed using user interface 132 on user computing device 130.

In an embodiment, shopping support program 122 considers certain fitments including, but not limited to, electric ports and light fittings. For example, the user wishes to visualize a lamp in the user's living room. Shopping support program 122 lays an image of the user's living room over the lamp to provide the user with a visualization of how the lamp will look in the user's living room. The user does not like the position of the lamp in the user's living room. Shopping support program 122 enables the user to rearrange the moveable items in the user's living room to fit the lamp.

In decision 440, shopping support program 122 determines whether the physical product can be overlaid at the first alternative micro location. In an embodiment, responsive to enabling the user to orient the physical product viewed in the first alternative micro location, shopping support program 122 determines whether the physical product can be overlaid at the first alternative micro location. If shopping support program 122 determines that the physical product can be overlaid at the first alternative micro location (decision 440, YES branch), then shopping support program 122 proceeds to step 470, generating a set of alternative options to the physical product viewed. If shopping support program 122 determines that the physical product cannot be overlaid at the first alternative micro location (decision 440, NO branch), then shopping support program 122 proceeds to step 450, automatically rearranging objects located within the user's preferred environment.

In step 450, shopping support program 122 automatically rearranges one or more moveable items located at the first alternative micro location. In an embodiment, responsive to determining the physical product cannot be overlaid at the first alternative micro location, shopping support program 122 automatically rearranges one or more moveable items located at the first alternative micro location. In an embodiment, shopping support program 122 automatically rearranges one or more moveable items located at the first alternative micro location in order for the physical product viewed to be overlaid at the first alternative micro location.

In decision 460, shopping support program 122 determines whether the physical product viewed can be overlaid at the first alternative micro location. In an embodiment, responsive to automatically rearranging one or more moveable items located at the first alternative micro location, shopping support program 122 determines whether the physical product viewed can be overlaid at the first alternative micro location.

If shopping support program 122 determines the physical product viewed can be overlaid at the first alternative micro location (decision 460, YES branch), then shopping support program 122 proceeds to step 465, enabling the user to choose between returning to step 360, selecting the physical product viewed to purchase, or proceeding to step 470, generating one or more alternative options to the physical product viewed. If shopping support program 122 determines the physical product viewed cannot be overlaid at the first alternative micro location (decision 460, NO branch), then shopping support program 122 proceeds to step 470, generating one or more alternative options to the physical product viewed.

In step 465, shopping support program 122 enables the user to choose either to return to step 360, selecting the physical product viewed to purchase, or to proceed to step 470, generating one or more alternative options to the physical product viewed. In an embodiment, responsive to determining the physical product viewed can be overlaid at the first alternative micro location, shopping support program 122 enables the user to choose either to return to step 360, selecting the physical product viewed to purchase, or to proceed to step 470, generating one or more alternative options to the physical product viewed. In an embodiment, shopping support program 122 enables the user to choose either to return to step 360, selecting the physical product viewed to purchase, or to proceed to step 470, generating one or more alternative options to the physical product viewed via user interface 142 of mixed reality device 140. In another embodiment, shopping support program 122 enables the user to choose either to return to step 360, selecting the physical product viewed to purchase, or to proceed to step 470, generating one or more alternative options to the physical product viewed via user interface 132 of user computing device.

In step 470, shopping support program 122 generates one or more alternative options to the physical product viewed. In an embodiment, responsive to determining the physical product viewed cannot be overlaid at the first alternative micro location, shopping support program 122 generates one or more alternative options to the physical product viewed. The one or more alternative options to the physical product viewed include, but are not limited to, a cross-sell product (i.e., a related or complementary product) and an up-sell product (i.e., a comparable higher-end product). In an embodiment, shopping support program 122 generates the one or more alternative options to the physical product viewed that better suit the user's preferred environment. In another embodiment, shopping support program 122 generates the one or more alternative options to the physical product viewed that have a better price tag. In another embodiment, shopping support program 122 generates the one or more alternative options to the physical product viewed that have a better review rating. In another embodiment, shopping support program 122 generates the one or more alternative options to the physical product viewed that fit in the user's preferred environment when the dimensions of the physical product viewed do not fit the user's preferred space.

In step 480, shopping support program 122 overlays an alternative option from the one or more alternative options to the physical product viewed at the first alternative micro location. In an embodiment, responsive to generating one or more alternative options to the physical product viewed, shopping support program 122 overlays an alternative option from the one or more alternative options to the physical product viewed at the first alternative micro location.

FIG. 5 is a block diagram illustrating the components of computing device 500 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made. Computing device 500 includes processor(s) 504, memory 506, cache 516, communications fabric 502, persistent storage 508, input/output (I/O) interface(s) 512, and communications unit 510. Communications fabric 502 provides communications between memory 506, cache 516, persistent storage 508, input/output (I/O) interface(s) 512, and communications unit 510. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a cross switch. Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Program instructions and data (e.g., software and data 514) used to practice embodiments of the present invention may be stored in persistent storage 508 and in memory 506 for execution by one or more of the respective processor(s) 504 via cache 516. In an embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508. Software and data 514 can be stored in persistent storage 508 for access and/or execution by one or more of the respective processor(s) 504 via cache 516. With respect to user computing device 130, software and data 514 includes user interface 132. With respect to server 120, software and data 514 includes shopping support program 122.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data (e.g., software and data 514) used to practice embodiments of the present invention may be downloaded to persistent storage 508 through communications unit 510.

I/O interface(s) 512 allows for input and output of data with other devices that may be connected to each computer system. For example, I/O interface(s) 512 may provide a connection to external device(s) 518, such as a keyboard, a keypad, a touch screen, and/or some other suitable input device. External device(s) 518 can also include portable computer readable storage media, such as, for example, thumb drives, portable optical or magnetic disks, and memory cards. Program instructions and data (e.g., software and data 514) used to practice embodiments of the present invention can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
detecting, by one or more processors, a user viewing a physical product via a mixed reality device;
identifying, by the one or more processors, a preferred environment for the physical product from a personal shopper profile of the user;
generating, by the one or more processors, via the mixed reality device a depiction of the preferred environment;
determining, by the one or more processors, whether the physical product can be overlaid in the preferred environment; and
enabling, by the one or more processors, the user to purchase a product based on the determination.

2. The computer-implemented method of claim 1, further comprising:
subsequent to enabling the user to purchase the product based on the determination, requesting, by the one or more processors, feedback from the user regarding the determination;
receiving, by the one or more processors, the feedback from the user;
improving, by the one or more processors, the accuracy of the determination using reinforcement learning; and
storing, by the one or more processors, the feedback from the user in a database.

3. The computer-implemented method of claim 1, wherein detecting the user viewing the physical product via the mixed reality device further comprises:
identifying, by the one or more processors, the physical product viewed by the user via the mixed reality device; and
downloading, by the one or more processors, a set of information about the physical product viewed from the personal shopper profile of the user onto the mixed reality device.

4. The computer-implemented method of claim 1, wherein the personal shopper profile of the user includes information about one or more shopping needs of the user, information about the physical product, information about the preferred environment, information about one or more shopping preferences of the user, and information about a budget of the user.

5. The computer-implemented method of claim 1, wherein determining whether the physical product can be overlaid in the preferred environment further comprises:
responsive to determining the physical product cannot be overlaid in the preferred environment, generating, by the one or more processors, one or more alternative micro locations within the preferred environment in which the physical product can be placed;
enabling, by the one or more processors, the user to select a first alternative micro location from the one or more alternative micro locations; and
enabling, by the one or more processors, the user to orient the physical product in the first alternative micro location.

6. The computer-implemented method of claim 5, further comprising:
subsequent to enabling the user to orient the physical product in the first alternative micro location, determining, by the one or more processors, whether the physical product can be overlaid in the first alternative micro location; and
responsive to determining the physical product cannot be overlaid in the first alternative micro location, automatically rearranging, by the one or more processors, the one or more moveable items located within the first alternative micro location in order for the physical product to be overlaid at the first alternative micro location.

7. The computer-implemented method of claim 6, further comprising:
subsequent to automatically rearranging the one or more moveable items located within the first alternative micro location in order for the physical product to be overlaid at the first alternative micro location, determining, by the one or more processors, whether the physical product can be overlaid at the first alternative micro location;
responsive to determining the physical product cannot be overlaid at the first alternative micro location, generating, by the one or more processors, one or more alternative options to the physical product; and
overlaying, by the one or more processors, an alternative option from the one or more alternative options to the physical product at the first alternative micro location.

8. The computer-implemented method of claim 7, wherein the one or more alternative options to the physical product includes a cross-sell product and an up-sell product.

9. A computer program product comprising:
one or more computer readable storage media and program instructions stored on the one or more computer readable storage media, the program instructions comprising:
program instructions to detect a user viewing a physical product via a mixed reality device;
program instructions to identify a preferred environment for the physical product from a personal shopper profile of the user;
program instructions to generate via the mixed reality device a depiction of the preferred environment;
program instructions to determine whether the physical product can be overlaid in the preferred environment; and
program instructions to enable the user to purchase a product based on the determination.

10. The computer program product of claim 9, further comprising:
subsequent to enabling the user to purchase the product based on the determination, program instructions to request feedback from the user regarding the determination;
program instructions to receive the feedback from the user;
program instructions to improve the accuracy of the determination using reinforcement learning; and
program instructions to store the feedback from the user in a database.

11. The computer program product of claim 9, wherein detecting the user viewing the physical product via the mixed reality device further comprises:
program instructions to identify the physical product viewed by the user via the mixed reality device; and
program instructions to download a set of information about the physical product viewed from the personal shopper profile of the user onto the mixed reality device.

12. The computer program product of claim 9, wherein determining whether the physical product can be overlaid in the preferred environment further comprises:
responsive to determining the physical product cannot be overlaid in the preferred environment, program instructions to generate one or more alternative micro locations within the preferred environment in which the physical product can be placed;
program instructions to enable the user to select a first alternative micro location from the one or more alternative micro locations; and
program instructions to enable the user to orient the physical product in the first alternative micro location.

13. The computer program product of claim 12, further comprising:
subsequent to enabling the user to orient the physical product in the first alternative micro location, program instructions to determine whether the physical product can be overlaid in the first alternative micro location; and
responsive to determining the physical product cannot be overlaid in the first alternative micro location, program instructions to automatically rearrange the one or more moveable items located within the first alternative micro location in order for the physical product to be overlaid at the first alternative micro location.

14. The computer program product of claim 13, further comprising:
subsequent to automatically rearranging the one or more moveable items located within the first alternative micro location in order for the physical product to be overlaid at the first alternative micro location, program instructions to determine whether the physical product can be overlaid at the first alternative micro location;
responsive to determining the physical product cannot be overlaid at the first alternative micro location, program instructions to generate one or more alternative options to the physical product; and
program instructions to overlay an alternative option from the one or more alternative options to the physical product at the first alternative micro location.

15. A computer system comprising:
one or more computer processors;
one or more computer readable storage media;
program instructions collectively stored on the one or more computer readable storage media for execution by at least one of the one or more computer processors, the stored program instructions comprising:
program instructions to detect a user viewing a physical product via a mixed reality device;
program instructions to identify a preferred environment for the physical product from a personal shopper profile of the user;
program instructions to generate via the mixed reality device a depiction of the preferred environment;
program instructions to determine whether the physical product can be overlaid in the preferred environment; and
program instructions to enable the user to purchase a product based on the determination.

16. The computer system of claim 15, further comprising:
subsequent to enabling the user to purchase the product based on the determination, program instructions to request feedback from the user regarding the determination;
program instructions to receive the feedback from the user;
program instructions to improve the accuracy of the determination using reinforcement learning; and
program instructions to store the feedback from the user in a database.

17. The computer system of claim 15, wherein detecting the user viewing the physical product via the mixed reality device further comprises:
program instructions to identify the physical product viewed by the user via the mixed reality device; and
program instructions to download a set of information about the physical product viewed from the personal shopper profile of the user onto the mixed reality device.

18. The computer system of claim 15, wherein determining whether the physical product can be overlaid in the preferred environment further comprises:
responsive to determining the physical product cannot be overlaid in the preferred environment, program instructions to generate one or more alternative micro locations within the preferred environment in which the physical product can be placed;
program instructions to enable the user to select a first alternative micro location from the one or more alternative micro locations; and
program instructions to enable the user to orient the physical product in the first alternative micro location.

19. The computer system of claim 18, further comprising:
subsequent to enabling the user to orient the physical product in the first alternative micro location, program instructions to determine whether the physical product can be overlaid in the first alternative micro location; and
responsive to determining the physical product cannot be overlaid in the first alternative micro location, program instructions to automatically rearrange the one or more moveable items located within the first alternative micro location in order for the physical product to be overlaid at the first alternative micro location.

20. The computer system of claim 19, further comprising:
subsequent to automatically rearranging the one or more moveable items located within the first alternative micro location in order for the physical product to be overlaid at the first alternative micro location, program instructions to determine whether the physical product can be overlaid at the first alternative micro location;
responsive to determining the physical product cannot be overlaid at the first alternative micro location, program instructions to generate one or more alternative options to the physical product; and
program instructions to overlay an alternative option from the one or more alternative options to the physical product at the first alternative micro location.
